(19) United States
(12) Patent Application Publication
(10) Pub. No.: US 2003/0126756 A1
(43) Pub. Date: Jul. 10, 2003

(54) Cabinet marking device

(76) Inventor: Tracy Edgar Ackerman, Colorado Springs, CO (US)

Correspondence Address: Law Office of Dale B. Halling, LLC, Suite 311, 24 South Weber Street, Colorado Springs, CO, 80903, US

(21) Appl. No.: 10/336,199

(22) Filed: Jan. 3, 2003

Related U.S. Application Data
(60) Provisional application No. 60/345,707, filed on Jan. 4, 2002.

(51) Int. Cl. G01B 5/14

(52) U.S. Cl. 33/528

(57) ABSTRACT

A cabinet marking device has a mating member. A plate has a first face and a second face. The first face is attached to the mating member. A marker is attached to a second face of the plate.

### RELATED APPLICATIONS

The present application claims priority on the provisional patent application entitled “Time Stamp”, filed on Jan. 4, 2002, having application Ser. No. 60/345,707.

### FIELD OF THE INVENTION

The present invention relates generally to the field of cabinet making tools and more particularly to a cabinet marking device.

### BACKGROUND OF THE INVENTION

Installing cabinets involves creating cutouts in the back of the cabinet for phone jacks, electrical outlets, data jacks, pipes, and etc. The present method of locating where the cutout should be placed is to measure from the outlet to where the edges of the cabinet are to be placed. This process requires at least two measurements and is fairly inaccurate. This process may take more than ten minutes per outlet. If a cutout is incorrectly placed it may require the cabinet to be reworked or significantly decease the esthetic appeal of the cabinet. This problem also exists when installing sheet rock, paneling, wainscoting and etc.

Thus there exists a need for a device that may be used to quickly and accurately locate a cutout for phone jacks, electrical outlets and related items.

### SUMMARY OF THE INVENTION

A cabinet marking device that overcomes these and other problems has a mating member. A plate has a first face and a second face. The first face of the plate is attached to the mating member. A marker is attached to a second face of the plate. In one embodiment, the marker is an ink absorbent pad. In another embodiment, the absorbent pad is made of a foam rubber.

In one embodiment, the mating member has a shape similar to an electrical plug. In another embodiment, the plate has a shape of an electrical outlet.

In one embodiment, the mating member is a male member that fits snuggly in a pipe. In another embodiment, the mating member has a shape similar to a phone jack.

In one embodiment a cabinet marking device includes a mating member. A plate has a first face and a second face. The mating member is connected to the first face. An ink absorbent foam pad is connected to the second face of the plate. In one embodiment, the mating member has a shape similar to a data jack. In another embodiment, the plate has a shape similar to a data jack face plate.

In one embodiment, the ink absorbent foam pad has a perimeter that has a shape similar to the data jack face plate. In another embodiment, the plate is made of a hard plastic. In another embodiment, the ink absorbent foam pad is glued to the plate.

In one embodiment, the mating member is formed out of the same material as the plate.

In one embodiment, a cabinet marking device has a mating member designed to mate with a wall socket or a pipe. A marking device is coupled to the mating member. In one embodiment, the marking device is an ink absorbent pad.

Note that while the invention is titled a cabinet marking device, it is intended for sheet rock, paneling, wainscoting and etc. These applications are also encompassed herein.

### BRIEF DESCRIPTION OF THE DRAWINGS

FIG. 1A is a side view of a cabinet marking device in accordance with one embodiment of the invention;

FIG. 1B is a front view of a cabinet marking device in accordance with one embodiment of the invention;

FIG. 1C is a back view of a cabinet marking device in accordance with one embodiment of the invention;

FIG. 1D is a front view of an electrical outlet that the cabinet marking device of FIGS. 1A-C is designed to work with in accordance with one embodiment of the invention;

FIG. 2A is a side view of a cabinet marking device in accordance with one embodiment of the invention;

FIG. 2B is a front view of a cabinet marking device in accordance with one embodiment of the invention;

FIG. 2C is a back view of a cabinet marking device in accordance with one embodiment of the invention;

FIG. 2D is a front view of an data jack outlet that the cabinet marking device of FIGS. 2A-C is designed to work with in accordance with one embodiment of the invention;

FIG. 3A is a side view of a cabinet marking device in accordance with one embodiment of the invention;

FIG. 3B is a front view of a cabinet marking device in accordance with one embodiment of the invention; and

FIG. 3C is a front view of an pipe that the cabinet marking device of FIGS. 3A-C is designed to work with in accordance with one embodiment of the invention.

### DETAILED DESCRIPTION OF THE DRAWINGS

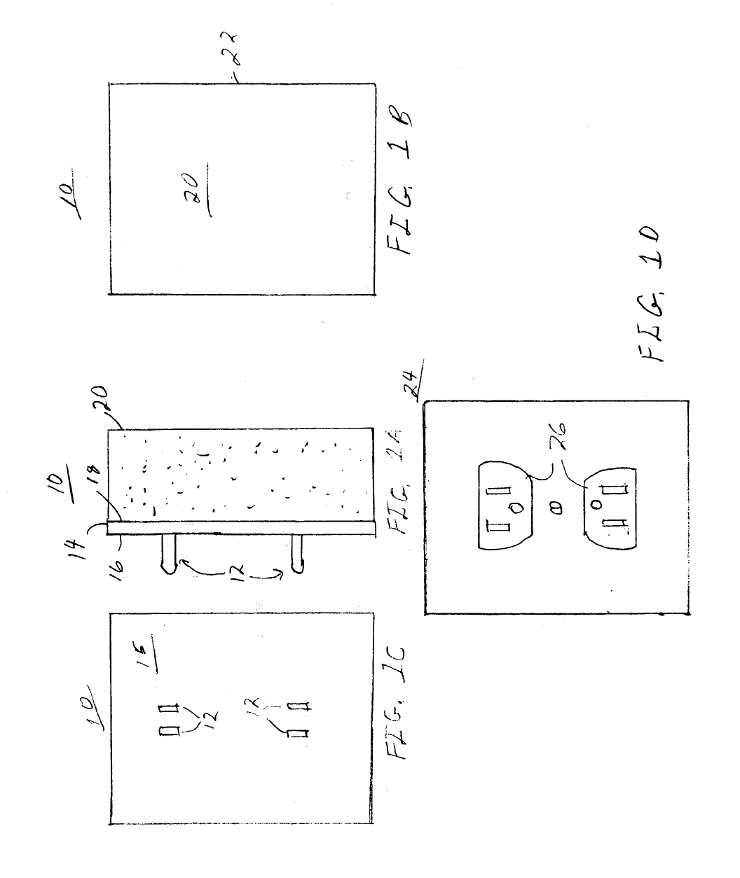

FIG. 1A is a side view of a cabinet marking device 10 in accordance with one embodiment of the invention. The device 10 may be used for marking the location of electrical outlets on cabinets, paneling, sheet rock, etc. The device 10 has a mating member 12. In this case the mating members 12 are designed to fit inside an electrical outlet and have a shape similar to an electrical plug. The mating members 12 are attached to a plate 14. The plate 14 has a first face 16 and a second face 18. The mating members 12 are attached to the first face 16 of the plate 14. In one embodiment, the plate 14 is made of a hard plastic and the mating members 12 are formed out the same material. A marker 20 is attached to a second face 18 of the plate 14. In one embodiment, the marker 20 is glued to the second face 18. In one embodiment, the marker 20 is an ink absorbent pad. The ink absorbent pad 20 is made of a foam rubber. In one embodiment, the marker 20 is attached directly to the mating members 12.

FIG. 1B is a front view of a cabinet marking device 10 in accordance with one embodiment of the invention. In this view the marker 20 is all that can be seen. The perimeter 22 of the marker is designed to have approximately the same shape as an electrical outlet faceplate.

FIG. 1C is a back view of a cabinet marking device 10 in accordance with one embodiment of the invention. The back view shows the mating members 12 on the first face 16 of the plate 14.

FIG. 1D is a front view of an electrical outlet 24 that the cabinet marking device of FIGS. 1A-C is designed to work with in accordance with one embodiment of the invention. The electrical outlet 24 has two female electrical outlets 26. The mating members 20 fit snuggly inside the female electrical outlets 26. This holds the cabinet marking device 10 in the electrical outlet 24. The marker 20 is embedded with ink, chalk or some other marking material. When a cabinet is placed in the appropriate position on the wall, the backside of the cabinet will press against the marker. This will leave a mark having an outline of the electrical outlet and its position on the backside of the cabinet. The installer then cuts out the portion of the backside of the cabinet that is marked. This is a quick, efficient and accurate way of determining where a cutout for an electrical outlet is needed.

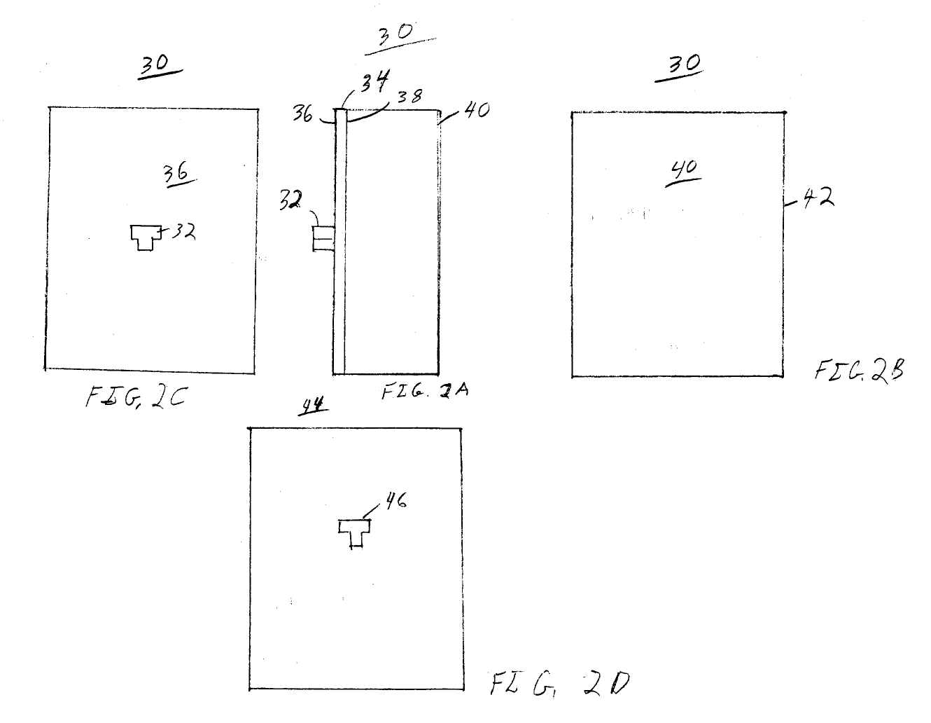

FIG. 2A is a side view of a cabinet marking device 30 in accordance with one embodiment of the invention. The device 30 is very similar to the device 10 of FIGS. 1A-C, except it is meant for a data outlet or phone jack. The mating member 32 is shaped like a male phone jack or data jack and is attached to a plate 34. The plate 34 has first side 36 and a second side 38. The mating member 32 is attached to the first side 36 of the plate 34. A marker 40 is attached to the second side 38 of the plate 34. FIG. 2B is a front view of a cabinet marking device 30 in accordance with one embodiment of the invention. This view just shows the marker 40. The perimeter 42 of the marker 40 has a shape similar to a data jack outlet faceplate or phone jack faceplate.

FIG. 2C is a back view of a cabinet marking device 30 in accordance with one embodiment of the invention. This view shows the mating member 32 attached to the first face 36 of the plate 34. FIG. 2D is a front view of an data jack outlet 44 that the cabinet marking device of FIGS. 2A-C is designed to work with in accordance with one embodiment of the invention. The data jack outlet 44 has a female data jack slot 46. The mating member 32 fits snuggly inside the female data jack slot 46 and holds the device 30 over the data jack outlet 44. The operation of the device is the same as device 10.

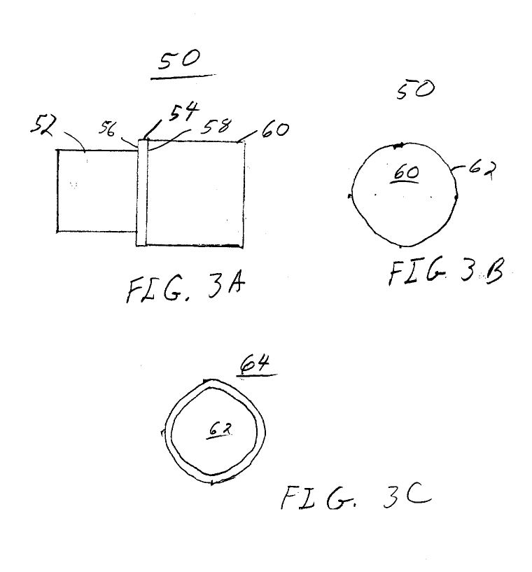

FIG. 3A is a side view of a cabinet marking device 50 in accordance with one embodiment of the invention. This embodiment of the device 50 is designed to mark the location of a pipe. The device has mating member 52 attached to a plate 54. The mating member 52 is a male member that fits in a pipe. The plate 54 has a first face 56 and a second face 58. The first face 56 is attached to the mating member 52. A marker 60 is attached to the second face 58. FIG. 3B is a front view of a cabinet marking device 50 in accordance with one embodiment of the invention. This view shows the marker 60. The perimeter 62 of the marker 60 has the same shape and size as the pipe being marked. FIG. 3C is a front view of an pipe 64 that the cabinet marking device 50 of FIGS. 3A-C is designed to work with in accordance with one embodiment of the invention. The mating member 52 fits snuggly in an opening 66 of the pipe 64. This holds the device 50 in place while the cabinet is being marked.

Thus there has been described a cabinet marking device that may be used to quickly and accurately locate a cutout for phone jacks, electrical outlets and related items. Note that several embodiments of the invention have been disclosed, however the invention encompasses related items like switch plates. In the case of switch plates the mating member would be modified. In one embodiment, the mating member is a female slot that attaches to the switch. In another embodiment, a suction plate or temporary glue is used to hold the device against the switch plate.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A cabinet marking device, comprising:
a mating member;
a plate having a first face and a second face, the first face attached to the mating member; and
a marker attached to a second face of the plate.

2. The device of claim 1, wherein the marker is an ink absorbent pad.

3. The device of claim 2, wherein the absorbent pad is made of a foam rubber.

4. The device of claim 1, wherein the mating member has a shape similar to an electrical plug.

5. The device of claim 4, wherein the plate has a shape of an electrical outlet.

6. The device of claim 1, wherein the mating member is a male member that fits snuggly in a pipe.

7. The device of claim 1, wherein the mating member has a shape similar to a phone jack.

8. A cabinet marking device, comprising:
a mating member;
a plate having a first face and a second face, the mating member connected to the first face; and
an ink absorbent foam pad connected to the second face of the plate.

9. The device of claim 8, wherein the mating member has a shape similar to a data jack.

10. The device of claim 9, wherein the plate has a shape similar to a data jack face plate.

11. The device of claim 10, wherein the ink absorbent foam pad has a perimeter that has a shape similar to the data jack face plate.

12. The device of claim 8, wherein the plate is made of a hard plastic.

13. The device of claim 12, wherein the ink absorbent foam pad is glued to the plate.

14. The device of claim 12, wherein the mating member is formed out of the same material as the plate.

15. A cabinet marking device, comprising:
a mating member designed to mate with a wall socket or a pipe; and
a marking device coupled to the mating member.

16. The device of claim 15, wherein the marking device is an ink absorbent pad.
